(19) United States
(12) Patent Application Publication
(10) Pub. No.: US 2026/0296086 A1
(43) Pub. Date: Oct. 1, 2026

(54) SYSTEMS AND METHODS FOR DEPOSITING AND IDENTIFYING DENDRITIC SHAPES

(71) Applicant: Avery Dennison Corporation, Mentor, OH (US)

(72) Inventors: Radha SEN, Mentor, OH (US); Reza MEHRABI, Tujunga, CA (US); Brad CUMBY, Liberty Township, OH (US); Collin G. MOORE, Chesterland, OH (US); Liviu DINESCU, Huntersville, NC (US)

(21) Appl. No.: 19/477,920

(22) PCT Filed: Jun. 18, 2024
(86) PCT No.: PCT/IB2024/055948

§ 371 Date: Oct. 23, 2025

Related U.S. Application Data
(60) Provisional application No. 63/509,559, filed on Jun. 22, 2023.

(51) Int. Cl. B41M 7/00; B32B 38/00; B41J 3/01; B41J 3/44; B41J 11/00; B41J 15/16; B41M 3/06

(52) U.S. Cl. CPC B41M 7/0027; B32B 38/145; B41J 3/01; B41J 3/44; B41J 11/0021; B41J 15/16; B41M 3/06; B41M 7/009

(57) ABSTRACT

This disclosure generally relates to adhesive films and laminates and methods for producing and using the same are described herein. Specifically, adhesive films and laminates and methods for producing the same including a unique dendrimeric shaped identifier are discussed herein.

### CROSS-REFERENCE TO RELATED APPLICATION(S)

The present application claims priority to and the benefit of U.S. Provisional Patent Application No. 63/509,559, filed Jun. 22, 2023, the entirety of which is incorporated herein by reference in its entirety.

### TECHNICAL FIELD

This disclosure generally relates to adhesive films and laminates and methods for producing and using the same are described herein. Specifically, adhesive films and laminates and methods for producing the same including a unique dendrimeric shaped identifier.

### BACKGROUND

Laminates are known in the art. Such products are provided in a variety of forms including, for example, tapes, sheets, and labels. Although satisfactory in many respects, a new class of laminates is needed which provide one or more functionalities, and which can be produced in a cost-efficient manner.

A variety of techniques are known for applying a coating or an adhesive to a face material. Methods are also known in which a coating or an adhesive is coated on a secondary material which is then combined with a face material. The coating or adhesive layer can be continuous or discontinuous. Discontinuous coating or adhesive layers typically include regular or uniform patterns or structures. Although such patterning may reduce the amount of adhesive used, the regular or uniform patterns or structures can have limitations, such as ungummed/uncoated edges of the label resulting in poor dispensing, flagging, poor print quality, and/or poor dye cutting. Although satisfactory in many respects, a need remains for additional strategies for depositing coating or adhesive on face materials in which particular properties and/or characteristics of the resulting structure can be maintained or improved.

Additionally, a need exists for materials with additional information, in a smaller area. This can promote sustainability as a way of reducing the area required to adequately convey information.

### SUMMARY

Exemplary embodiments relate to a system comprising: a control unit; at least one motor; at least one ink unit adapted to dispense ink that can be formed into in a dendritic trunk pattern; at least one ink unit adapted to dispense ink in that can be formed into a dendritic branch pattern; a first roll driven by the at least one motor operative to unwind the substrate; a laminator unit with at least one roll assembly; and a second roll driven by the at least one motor and adapted to wind a laminate structure. This embodiment or another exemplary embodiment provides a spray unit operative to spray a protective varnish. This embodiment or another exemplary embodiment provides at least one radiation source operative to cure the ink into a dendritic ink pattern. This embodiment or another exemplary embodiment provide for the at least one radiation source is selected from the group of: an actinic radiation source and an infrared radiation source. This embodiment or another exemplary embodiment provide for the at least one ink unit is at least one piezo controlled device operating between about 1000 Hz and about 10000 Hz, disposed between about 0.1 mm to about 3 mm longitudinally above the substrate. This embodiment or another exemplary embodiment provide for the at least one ink unit is at least one solenoid actuated pneumatic nozzle operating between about 100 Hz and about 1000 Hz. This embodiment or another exemplary embodiment provide for the at least one ink unit is at least one automatic syringe with an internal needle diameter between about 0.1 mm and about 0.5 mm and disposed between about 0.1 mm to about 1 mm longitudinally above the substrate. This embodiment or another exemplary embodiment provide a substrate adapted to receive the ink, wherein the substrate is polymeric and has greater than about 30 dyne/cm of surface energy. This embodiment or another exemplary embodiment provide a second layer, wherein the second layer is applied through the laminator unit and wherein the second layer has less than or equal to the surface energy of the substrate. This embodiment or another exemplary embodiment provide for the second layer is the same material of the substrate. This embodiment or another exemplary embodiment provide for the second layer is a different material as the substrate. This embodiment or another exemplary embodiment provide for the dendrite ink precursor has a viscosity that is between about 1000 cps and about 5000 cps. This embodiment or another exemplary embodiment provide the ink comprises at least one of pigments, conductive metal flakes, sintered metal, and fused metal.

In another embodiment provided is a method, comprising: providing a printer system, comprising: a control unit, at least one ink unit, a substrate on a first roll, a laminator with a pressing roll, at least one radiation source, and a second roll; unrolling at least a portion of the substrate from a first roll; generating a dendritic trunk pattern via ink by the at least one ink unit onto the substrate; generating a dendritic branch pattern via ink by the at least one ink unit onto the substrate; laminating at least one layer onto the ink with the laminator and the pressing roll; exposing the ink; curing the ink with the at least one radiation source resulting in a set dendritic ink pattern; and winding a resultant patterned ink containing laminate onto the second roll. This embodiment or another exemplary embodiment provide for providing a varnish to the laminate. This embodiment or another exemplary embodiment provide for laminating an optically transparent layer over the dendritic ink pattern. This embodiment or another exemplary embodiment provide for recording a shape of the exposed section of the dendritic ink containing laminate with a detector; and creating a data bearing record related to the shape. This embodiment or another exemplary embodiment provide for the generating of the ink pattern occurs by at least one piezo controlled device operating between about 1000 Hz and about 10000 Hz, disposed between about 0.1 to about 3 mm longitudinally above the substrate. This embodiment or another exemplary embodiment provide heating the piezo controlled device to about 100° C. This embodiment or another exemplary embodiment provide for the generating of the ink pattern occurs by at least one automatic syringe with an internal needle diameter between about 0.1 and about 0.5 mm and disposed between about 0.1 to about 1 mm longitudinally above the substrate.

### BRIEF DESCRIPTION OF THE DRAWINGS

FIG. 1 is a cross sectional schematic illustration of a dendritic pattern on a substrate in accordance with the present subject matter.

FIG. 2 is a cross sectional schematic along line 2-2 of FIG. 1 illustration of a dendritic pattern regions on a substrate in accordance with the present subject matter.

FIG. 3 is a planar illustration of an exemplary implementation of a label with a dendritic pattern as discussed herein.

FIG. 4 is a cross sectional schematic illustration along line 4-4 of FIG. 3 of an exemplary implementation of a label.

FIG. 5 is a cross sectional schematic illustration along line 4-4 of FIG. 3 of an alternative implementation.

FIG. 6 is a planar illustration of another exemplary implementation of a label with a dendritic pattern as discussed herein.

FIG. 7 is a cross sectional schematic illustration along line 7-7 of FIG. 6 of an exemplary implementation of a label.

FIG. 8 is a planar illustration of yet another exemplary implementation of a label with a dendritic pattern as discussed herein.

FIG. 9 is a cross sectional schematic illustration along line 9-9 of FIG. 8 of an exemplary implementation of a label with a depositor nozzle active.

FIG. 10 is a schematic view of an exemplary roller configuration as discussed herein.

FIG. 11A is an exemplary embodiment of a roller assembly.

FIG. 11B is another exemplary embodiment of a roller assembly.

FIG. 11C is an yet another exemplary embodiment of a roller assembly.

FIG. 11D is another further exemplary embodiment of a roller assembly.

FIG. 12 is systematic block diagram of an exemplary system discussed herein.

### DEFINITIONS

As used herein the term “dendritic” relates to highly ordered, branched micropattern shapes, of which specific reference is made to the IUPAC Recommendations publication “Nomenclature and terminology for dendrimers with regular dendrons and for hyperbranched polymers (IUPAC Recommendations 2017)” and is herein incorporated by reference.

As used herein “optically transparent” refers to a property of a material that refers to the ability of the material to allow part of the electromagnetic spectrum (e.g. light waves) to pass through, specifically in the visible spectrum with wavelengths of about 380 nanometers to about 750 nanometers. “Optically transparent” as used herein refers to any material that does not have 100% impendence of electromagnetic energy (e.g. light waves). An optically transparent material can allow 1% to 100% of all light waves or other electromagnetic energy to pass through.

As used herein, “exposed” or “exposing” refers to the state of a material not covered or otherwise obstructed by a layer of material, or if there is a physical covering of material, that material is optically transparent. In short, “exposed” refers to the fact that there is no obstacle, obstruction, or barrier for a sensor or other similarly situated optical unit to detect the materials described within this disclosure.

As used herein, the term “laminate” means, with respect to a construction, at least one adhesive coated material, generally with one or more additional layers. Non-limiting examples of such layers to make up the multilayer include protective layers, spacing layers, adhesive layers, optical component-containing layers, metallic layers, barrier layers, release liners, tie coat layers, clear layers, color layers, white layers, reflective layers, fluid transfer layers, strength promoting layers, topcoats, print receptive layers, print containing layers, indicia layers, functional layers, and the like as well as combinations thereof. The resultant multilayer laminate construction described herein can be used for a variety of applications including, but not limited to, graphics applications, such as automobile and architectural wraps; reflective applications, such as road and traffic signs, trains and other commercial vehicles, etc.; and label and packaging applications.

### DETAILED DESCRIPTION

### Adhesives

The laminates/constructs described herein contain one or more adhesives. The adhesive(s) can be a PSA, a non-pressure sensitive adhesive, a hot-melt adhesive, or combinations thereof. In some embodiments, the adhesive is a PSA. The PSA may be any known PSA. In some embodiments, the PSA is a solvent type adhesive, an emulsion type adhesive, or non-emulsion type adhesive. In some embodiments, the PSA is an emulsion adhesive. Hot melt PSAs may also be used. The adhesive may be acrylic or any other useful adhesive which has the hardness and adhesive properties needed for the laminates and/or adhesive coated facestocks. In certain embodiments, the adhesive should have a hardness sufficient to prevent the adhesive squeezing out of the laminate or article during processing.

Exemplary PSAs may be found in (1) Encyclopedia of Polymer Science and Engineering, Vol. 13, Wiley-Interscience Publishers (NewYork, 1988); (2) Polymer Science and Technology, Vol. 1, Interscience Publishers (New York, 1964); (3) those described in U.S. Pat. Nos. 5,164,444; 5,183,459; and 5,264,532, all issued to Bernard, and U.S. Pat. No. 5,385,965, issued to Bernard et al; and (4) combinations thereof. The PSAs may be a solvent based or may be a water based adhesive. Conventional PSAs, including acrylic-based PSAs, rubber-based PSAs and silicone-based PSAs may be used in the laminates/constructs described herein. In one embodiment, the pressure sensitive adhesive contains an acrylic emulsion adhesive.

In some embodiments, the pressure sensitive adhesive is prepared by polymerizing alkyl acrylates, vinyl esters, diesters of dicarboxylic acids and unsaturated acids. The alkyl acrylates typically contain from about 2 to about 12, or from about 4 to about 8 carbon atoms in the alkyl group. Examples of alkyl acrylates include, but are not limited to, ethyl, n-butyl, hexyl, 2-ethylhexyl, and isooctyl acrylates, with 2-ethylhexyl acrylate preferred. In one embodiment, the alkyl acrylates are present in an amount of at least about 35%. In some embodiments, the alkyl acrylates are present in an amount from about 35% to about 60% by weight.

The vinyl esters typically have from about 2 to about 12, or from about 4 to about 8 carbon atoms in the alkyl group. Examples of vinyl esters include, but are not limited to, vinyl acetate, vinyl propionate, vinyl butyrate, vinyl versatate and the like, with vinyl acetate being preferred. In some embodiments, the vinyl esters are present in an amount from about 15% to about 35% or from about 20% to about 25% by weight.

The diesters of the dicarboxylic acids include alkyl esters of unsaturated diacids, such as maleic acid or anhydride and fumaric acids. The alkyl group generally contains from about 2 to about 20, or from about 4 to about 16, or from about 6 to about 12 carbon atoms. Examples of diesters of diacids include, but are not limited to, butyl, octyl fumarate; hexyl, decyl maleate; di-2-ethylhexyl maleate; di-butyl fumarate; and di-2-ethylhexyl fumarate and mixtures thereof. In some embodiments, the diesters of diacids are present in an amount from about 20% to about 35% by weight.

The unsaturated acids generally contain from about 2 to about 12, or from about 2 to about 6 carbon atoms. Examples of the unsaturated acids include, but are not limited to, acrylic acid, methacrylic acid, itaconic acid, and the like. In some embodiments, the unsaturated acids are present in an amount up to 5% or from about 1% to about 3% by weight.

In exemplary embodiments, the coat weight of adhesives may be between 2 and 100 gsm.

### Release Liners

In some embodiments, the laminates described herein may include one or more release liner(s). The liner may have a first side, a second side opposed to the first side, a first edge, and a second edge opposed to the second edge. The liner may be any useful liner which provides necessary support and release properties. The liner may be made of, or from, a variety of materials including, but not limited to, paper or polymer film liners. In one embodiment, the caliper of the paper is sufficient to die cut the resulting laminate or article. For example, liner calipers can range from about 18 mm to 23 mm for PET liners. In one embodiment, the liner has lay flat properties. In some embodiments, the liner has a machine glaze or finish. In some embodiments, the liner has a silicone hold out layer. The hold out layer provides adhesion between the release coating and the release liner. The silicone holdout layer also prevents the silicone release coating from soaking into the liner.

In some embodiments, the release liner includes a liner having a release coating. The release coating of the release liner provides a releasable bond with the PSA or other adhesive. The release coating may be any composition which provides a desired releasable bond strength.

In one embodiment, the release coating is a silicone release coating. The release coating can be prepared by curing silicone polymers in the presence of a control release agent. In some embodiments, the control release agent is a copolymer of a monofunctional silicone unit of the formula R₃SiO_{1/2} and tetrafunctional silicone units SiO_{4/2} wherein R is an alkyl or alkenyl group. In one embodiment, the alkyl or alkenyl groups contain from about 1 to about 12, or from about 1 to about 6 carbon atoms. Non-limiting examples of alkyl and alkenyl groups include methyl, ethyl, propyl, butyl, hexyl, ethenyl, propenyl, butenyl and hexenyl groups.

The control release agent is typically reacted with a polysiloxane. The polysiloxane may be any polysiloxane which is useful in forming a release coating. Examples of useful polysiloxanes include, but are not limited to, vinyl terminated, hydroxy terminated and epoxy terminated polysiloxanes. In one embodiment, the polysiloxane is a functional polydialkyl siloxane, wherein the alkyl group contains from about 1 to about 6 carbon atoms. The alkyl groups independently include, but are not limited to, methyl, ethyl, propyl, butyl, pentyl, hexyl groups or mixtures thereof. In one embodiment, the alkyl or alkenyl group contains from 1 to about 12, or from 1 to about 6 carbon atoms. The polysiloxane typically has a viscosity average molecular weight of greater than 300,000 centipoise (cps). In another embodiment, the polysiloxane has a viscosity molecular weight from about 300,000 to about 1,000,000 or more. The polysiloxane may be represented by the formula (1):

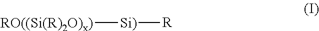

wherein each R is independently as defined above and x is an integer.

In some embodiments, the release coating is prepared with a cross linking agent. In some embodiments, the cross linking agent is a reactive polysiloxane, such as a polydialkyl or polyhydroalkyl siloxane. The alkyl groups are the same as those described above.

The release coating may be applied in a solvent, solvent-less or emulsion form. The release coating may be cured by any known curing process, e.g. thermal, radiation, etc., to form the release coating. The curing may be catalyzed by silicone soluble complexed compounds of Group VIII transition metals, such as platinum.

Commercially available release agents include, but are not limited to, GE SS-4335, a silicone release agent in unreactive solvent. Commercially available polysiloxanes include, but are not limited to, GE SS-4331, a vinyl terminated polydimethyl siloxane. Commercially available linking agents include, but are not limited to, GE SS-4300C, a polymethyvinyl siloxane. Exemplary catalysts include, but are not limited to, SS-8010 catalyst in toluene. These materials are available commercially from General Electric Company's Silicone Products Division. Similar silicone products are available under the tradename Syl-off from Dow Corning Corporation.

It will be understood that the present subject matter is not limited to any of the noted release coatings or agents, and instead includes nearly any release coating or agent suitable for the intended end use application. Furthermore, although the present subject matter has been described in association with release liners, it will be appreciated that appropriately configured carrier films and other members could be used instead of release liners.

### Face Material

Suitable face materials include, but are not limited to, synthetic papers such as polyolefin type and polystyrene type; various plastic films or sheets such as polyolefin, polyvinyl chloride, polyethylene terephthalate, polystyrene, polyurethane, polymethacrylate and polycarbonate. Additional examples of suitable face materials include paper and cardboard. The face material may be, or may include, a multilayer polymeric sheet. The multi-layers may be coextruded, or the multi-layers may be laminated together. In one embodiment, the face material includes both co-extruded multi-layers and laminated multi-layers. In addition, a white opaque film may be formed by adding a white pigment to one or more of the aforementioned synthetic resins and used as the face material. In one embodiment, a foamed film is used as the face material. The foamed film may be formed by a conventional foaming operation. In another embodiment, the face material may be a laminated body formed by combining a plurality of single layered sheets composed of the above listed materials. Examples of such a laminated body may include the combination of cellulose fiber paper with synthetic paper, and a laminated body of combined cellulose fiber paper with a plastic film or sheet. In another suitable embodiment, the face material includes coated and uncoated papers, metalized papers, aluminum foil, laminated paper and paper with a polymeric material extruded onto the surface of the paper. In certain versions, the face material can be coated with a liquid absorbent material. The selected face material may be porous or semi-porous. The face material may exhibit certain visibility characteristics such as opaqueness, color, and/or brightness. The face material may include water or other liquid absorbency properties. The face material may be electrically conductive and/or include electrically conductive coatings or regions. A wide array of commercially available face materials can be used such as for example those available under the designation TESLIN.

The thickness of the face material is optionally determined with reference to application specific criteria. Such criteria may include the desired end use. In one embodiment, the sheet thickness is in a range of from about 10 μm to about 300 μm. In another embodiment, the sheet thickness is in a range of from about 20 μm to about 200 μm. In still another embodiment, the sheet thickness is in a range of from about 30 μm to about 150 μm. Optionally, a primer treatment or a corona discharging treatment or a plasma treatment may be used on the face material to increase a bonding strength between the face material and a dried topcoat composition to be formed on a surface of the face material.

In certain embodiments described herein, the face material exhibits one or more functions or functional characteristics. For example, the face material may be selected to enable or promote an indication such as a visual indication of a liquid, outgassing such as directing or allowing flow of air or gas across a thickness of the face material, water or liquid retention within the face material, electrical discharge or conductivity of the face material, chemical delivery across a thickness of the face material, passage of sound across a thickness of the face material, and/or combinations of these functions or characteristics.

### Optional Layers

The adhesive coated face material and/or laminates described herein can include one or more additional layers or components. Non-limiting examples of such layers include protective layers, tie coat layers, clear layers, color layers, white layers, reflective layers, fluid transfer layers, strength promoting layers, topcoats, print receptive layers, print containing layers, indicia layers, functional layers, and the like.

### Laminate Properties

The laminates described herein may have specific and useful properties or functionalities. In some embodiments, the techniques described herein enable formation of laminates in which transfer, propagation, and/or migration of liquid, gas, sound waves, electrical current, and/or other agents or elements can occur and is controlled across or through the laminate in a Z-direction. The reference to “Z-direction” as made herein refers to a direction across a thickness dimension of a laminate or portion thereof, and thus references to “X-direction” and/or “Y-direction” refer to directions perpendicular to the Z-direction and correspond to width and length dimensions of the laminate.

Non-limiting representative examples of laminates having certain functionalities which are provided by the present subject matter include liquid indicator laminates, outgassing laminates, water absorbent laminates, sound channeling laminates, electrically conductive laminates, and laminates having combinations of these functionalities and/or laminates having combinations of one or more of these functionalities and additional functionalities.

For example, a liquid indicator laminate can be produced such that the speed of the indicator color change is linked to the facestock selection and porous adhesive properties. A discontinuous structure, such as resulting from pores in the adhesive layer or region(s), can allow, for example, liquid to channel through the discontinuous adhesive from one side of the adhesive to the other side and create a permanent discoloration when a dye or other agent in a functional coating in the laminate is dissolved.

In one embodiment, a liquid indicator laminate is provided. The speed or rate of the indicator color change is linked to the facestock properties such as for example absorbency of liquid, and porosity of the pattern adhesive in the Z-direction. The indication typically is irreversible and can be measured by color change or by a simple visual comparison.

The discoloration of a face or region of the laminate can be measured and quantified by optical change, such as by CIE Lab or by a simple visual comparison. The discoloration can be permanent or nonpermanent. The discoloration can also be temporary and revert to an initial state after passage of a period of time. In some embodiments, the period of time is predetermined.

This phenomenon of transport through discontinuities in an adhesive in the Z-direction can be implemented in other label applications and particularly pressure sensitive adhesive labels, such as for example, labels for outgassing substrates such as by air channeling in the Z-direction, moist substrate labeling such as by liquid channeling in the Z-direction, electrical discharge in the Z-direction, chemical delivery from one layer to another in the Z-direction, and/or sound channeling in the Z-direction. This phenomenon enables passage, transfer, and/or migration of a medium or agent from one side of an adhesive region of a laminate, to another side of the adhesive region. Although medium penetration or transport is noted as being in the Z-direction, it will be understood that the present subject matter is not limited to such and may also include penetration/transport in the X-direction and/or Y-direction.

In some embodiments, the laminates described herein include a layer or region of a secondary adhesive. The secondary adhesive is typically utilized to adhere the laminate to a substrate of interest. The secondary adhesive may contain one or more adhesives which are the same or different than the adhesive of the patterned or porous adhesive. Description of representative examples of secondary adhesives are provided herein. In such an adhesive configuration, the primary adhesive may be coated onto the facestock, the secondary adhesive may be coated onto the release liner, and the coated adhesive and release liner may be laminated together such that the primary and secondary adhesives are in direct contact with each other. Alternatively, or additionally, both the primary and secondary adhesive may be coated on the facestock or the release liner, then laminated together. It is contemplated that the layering of the primary and secondary adhesive relative to the facestock and the release liner may be either facestock, primary adhesive, secondary adhesive, and release liner or facestock, secondary adhesive, primary adhesive, release liner. Regardless of the order of primary and secondary adhesive, it is contemplated that at least one of the primary and secondary adhesive is patterned, taking into consideration that the other adhesive may be continuous.

In some embodiments, an array of different arrangements of layers and components may be utilized. In some embodiments using the patterned adhesive, e.g., the layer of discontinuous adhesive, that layer is disposed between a functional facestock and a liner or functional layer. And in the liquid indicator laminates, the patterned adhesive may be disposed between the functional facestock and the layer or region of functional agent that is sensitive to liquid passing through the laminate. And, in the liquid indicator laminates, the layer or region of the functional agent may be disposed between the patterned adhesive and the carrier layer.

Utilization of the techniques and features described herein enable production of adhesive laminates and/or adhesive coated face materials with fluid/air management characteristics, controlled removability, and/or unique thermal and/or electrical conductivity. In addition, use of these techniques and features enable reductions in materials, e.g., adhesives, and thus enable cost savings. However, it will be understood that the present subject matter includes the adhesive coated face materials and laminates described herein which are formed by other methods than the methods described herein.

### Top Coat Formulation and Application

In exemplary embodiments discussed herein, the top coat coating is deposited on the substrate by any suitable method. In embodiments, the suitable method includes any suitable coating technology. Embodiments include depositing the coating on the substrate by any suitable liquid deposition method. Without limitation, examples of suitable methods include bath coating, spray coating, slot coating, spin coating, curtain coating, gravure coating, reverse gravure print coating, reverse roll coating, knife over roll (i.e., gap) coating, metering (Meyer) rod coating, air knife coating, or any combinations thereof. Bath coating includes immersion or dip in the aqueous solution. In an embodiment, the coating is deposited by bath in the aqueous solution. In other embodiments, the coating is deposited by spray of the aqueous solution.

### Inks

Within exemplary embodiments, there is an ink or print layer. This ink layer can be an ink or graphics layer, and the print layer may be a mono-colored or multi-colored print layer depending on the printed message and/or the intended pictorial design. These include variable imprinted data such as serial numbers, bar codes, trademarks, etc. The thickness of the print layer is typically in the range of about 0.5 to about 10 microns, and in one embodiment about 1 to about 5 microns, and in another embodiment about 3 microns. The inks used in the print layer include commercially available water-based, solvent-based, silicone based, or radiation-curable inks. Examples of these inks include Sun Sheen (a product of Sun Chemical identified as an alcohol dilutable polyamide ink), Suntex M P (a product of Sun Chemical identified as a solvent-based ink formulated for surface printing acrylic coated substrates, PVDC coated substrates and polyolefin films), X-Cel (a product of Water Ink Technologies identified as a water-based film ink for printing film substrates), Uvilith AR-109 Rubine Red (a product of Daw Ink identified as a UV ink) and CLA91598F (a product of Sun Chemical identified as a multibond black solvent-based ink), Lexmark laser printer or toner inks, and Xerox laser printer or toner inks.

In one embodiment, the print layer comprises a polyester/vinyl ink, a polyamide ink, an acrylic ink and/or a polyester ink. The print layer may be formed in the conventional manner by, for example, gravure, flexographic or UV flexographic printing or the like, an ink composition comprising a resin, a suitable pigment or dye and one or more suitable volatile solvents onto one or more desired areas of the film. After application of the ink composition, the volatile solvent component(s) of the ink composition evaporate(s), leaving only the non-volatile ink components to form the print layer.

The adhesion of the ink to the surface of the polymeric film can be improved, if necessary, by techniques well known to those skilled in the art. For example, as mentioned above, an ink primer or other ink adhesion promoter can be applied to the polymeric film layer or other underlying layer before application of the ink. Alternatively, the surface of the polymeric film can be corona treated or flame treated to improve the adhesion of the ink to the polymeric film layer.

Useful ink primers may be transparent or opaque and the primers may be solvent based or water-based. In one embodiment, the primers are radiation curable (e.g., UV). The ink primer may comprise a lacquer and a diluent. The lacquer may be comprised of one or more polyolefins, polyamides, polyesters, polyester copolymers, polyurethanes, polysulfones, polyvinylidine chloride, styrene-maleic anhydride copolymers, styrene-acrylonitrile copolymers, ionomers based on sodium or zinc salts or ethylene methacrylic acid, polymethyl methacrylates, acrylic polymers and copolymers, polycarbonates, polyacrylonitriles, ethylene-vinyl acetate copolymers, and mixtures of two or more thereof. Examples of the diluents that can be used include alcohols such as ethanol, isopropanol and butanol; esters such as ethyl acetate, propyl acetate and butyl acetate; aromatic hydrocarbons such as toluene and xylene; ketones such as acetone and methyl ethyl ketone; aliphatic hydrocarbons such as heptane; and mixtures thereof. The ratio of lacquer to diluent is dependent on the viscosity required for application of the ink primer, the selection of such viscosity being within the skill of the art. The ink primer layer may have a thickness of from about 1 to about 4 microns or from about 1.5 to about 3 microns.

In the exemplary embodiments, in addition to the variable imprinted data such as serial numbers, bar codes, trademarks, etc., there is a printed unique identifier structure. The unique identifier structure can include filler such as pigments, dyes, Near-IR (NIR) dyes, metal flakes, conductive metal precursors, and reflective materials. In the exemplary embodiment, the ink may be conductive. Additionally included in an exemplary embodiment may be one or more taggant. Taggants are unique chemical compounds that come along with a specific detector. Taggants have many uses; security ink is one of them, where the taggant can act as a form of anti-counterfeiting. These anti-counterfeit inks can be used on security labels or even on product packaging itself, as they're well-suited to be used on myriad substrates. The features of taggants that make them suitable for anticounterfeiting measures include being: uniquely encoded like a fingerprint, able to be visible or invisible to the naked eye, able to be detected with special equipment, able to be field-tested with low-cost detectors, and permanent and unremovable once integrated into an item. The printed unique identifier may have a viscosity between about 1000 cps and about 100000 cps. In exemplary embodiments the surface tension of the unique identifier structure is less than 50 dyne/cm. In other embodiments, the surface tension of the unique identifier structure is less than 40 dyne/cm. In yet other embodiments, the surface tension of the unique identifier structure is less than 30 dyne/cm.

The unique identifier structure is deposited in a specific dendritic shape. Specifically, the unique identifier structure can be deposited in two different pieces, a dendrimer trunk pattern and a dendrimer branch pattern. The dendrimer trunk pattern is one of a relatively large pattern of which various pieces of the dendrimer branch pattern will come off of the trunk. In certain embodiments, the dendrimer trunk pattern may include a Radio Frequency Identification (RFID) chip embedded within it. The dendrimer branch pattern allows for various branches to be taken off the trunk in a semi-random or pseudo-random pattern, this will be discussed in greater detail with respect to laminate structures below.

Additionally, in an exemplary embodiment the ink may be a fluid capable of responding to changes in polarity. This may allow the pattern to be selectively tuned using magnetism or other external forces in order to best manipulate the given desired shape. Alternatively or additionally, additives present in the ink may be use to control the wetting nature of the ink.

The ink as well as the printed unique identifier can be applied using various nozzles. In one embodiment, the printed unique identifier is applied using at least one piezo nozzle or an electrical pneumatic nozzle. The exemplary piezo nozzle may operate between about 1000 Hz and about 10000 Hz while the exemplary electrical pneumatic nozzle may operate between about 100 Hz and about 1000 Hz. Each of the exemplary piezo nozzle or the electrical pneumatic nozzle can be placed from about 10 μm to about 3 mm above the substrate and heated up to about 100° C.

In another embodiment, the printed unique identifier is applied using at least one syringe injector. The at least one syringe injector may be placed from about 0.1 mm to about 1 mm above the substrate. A needle of the syringe injector can have an internal diameter between about 0.1 mm and about 0.5 mm. The syringe as well can be heated up to about 100° C. All of the discussed embodiments may result in a diameter of a pattern between about 0.002 mm and about 0.5 mm.

In yet another embodiment, the printed unique identifier is applied using at least one stencil screen print or rotary screen. In yet another embodiment, the printed unique identifier is applied using electrostatic printing. These embodiments will be discussed later with respect to operation. Any or all of these ink deposition techniques can result in a three-dimensional shape, and this three-dimensional shape may have specific properties that will be discussed and identified within the methods below.

### Radiation Source

The exemplary embodiment provides for the radiation source. In an exemplary embodiment, the radiation source is an actinic radiation source. In this or another exemplary embodiment, the radiation source is at least one ultraviolet laser emitting diode (UV-LED). In the exemplary embodiments, the radiation source is not anticipated of comprising mercury lamps. For the desired implementation, mercury lamps generate too much heat and the resultant films will simply melt or deform when printing layers.

There may be a plurality of UV-LED units, specifically leading and trailing lamps that are operative to cure both the ink as well as the coating. Each of the UV-LED units may be independently controlled. When there is one or more UV-LED unit, they could be emitting the same wavelength, or different wavelengths. In the instance where they are emitting different wavelengths, this could be in a dual-curing system where one or more photoinitiators with different wavelengths of activation are used.

In other embodiments, the radiation source is providing heat and may be a heat source operative to dry, and optionally to sinter and/or fuse ink particles together.

### Exemplary Laminate Structures

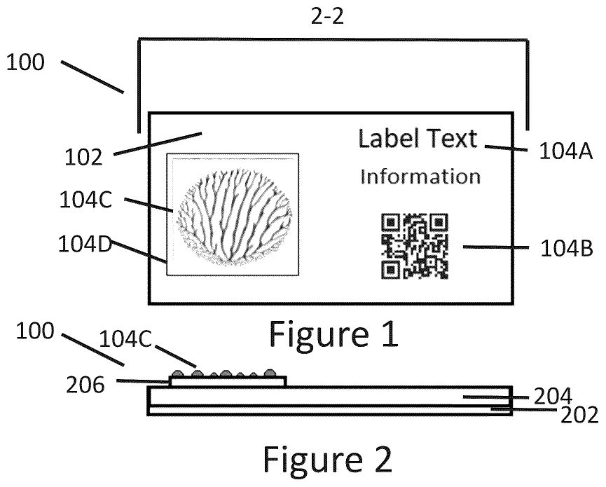

One such laminate structure envisioned in accordance with the disclosure is a label on label approach. This structure is shown on FIG. 1 and FIG. 2. Referring specifically to FIG. 1, a top planar view of such an exemplary construction is shown. A label 100 is shown with various components on a top face 102 of the label 100 including various identifying indicia 104A, 104B and 104C. In this embodiment, there is a place for text identifying information 104A, a QR code 104B, as well as a dendritic pattern 104C. The dendritic pattern 104C is optically isolated by virtue of an outer border 104D.

Referring specifically to FIG. 2, a cross-sectional view of the laminate structure of FIG. 1, along line 2-2 is shown. In this view, there is a substrate layer 202, followed by a label stock 204, and then a secondary label 206 where the dendritic pattern 104C is deposited. With the dendritic pattern 104C deposited in this way, this allows for a three-dimensional touch and feel. Additional security features may be included and can include, but are not limited to, at least one taggant, metal flakes, or other detectable markers.

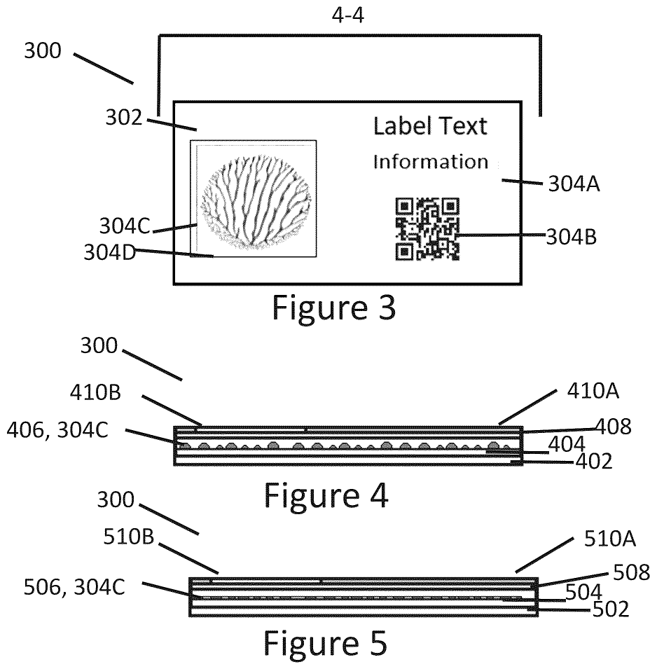

In another exemplary laminate structure, the pattern can be applied underneath a portion of the laminate structure. This structure is shown on FIG. 3, FIG. 4 and FIG. 5. Referring specifically to FIG. 3, a top planar view of such an exemplary construction is shown. A label 300 is shown with various components visible from its top face 302 of the label 300 including various identifying indicia 304A, 304B and 304C. In this embodiment, there is a place for text identifying information 304A, a QR code 304B, as well as a dendritic pattern 304C. The dendritic pattern 304C is optically isolated by virtue of an outer border 304D.

Referring specifically to FIG. 4, a cross-sectional view of the laminate structure of FIG. 3, along line 4-4 is shown. In this view, there is shown a substrate layer 402, an adhesive substrate layer 404 followed by a coating or adhesive layer 406 where the dendritic pattern 404C, an optically clear layer 408, and a mask layer 410A with an optically clear window 410B each the mask layer 410A and optically clear window 410B comprising the top face 402. Additional security features may be included and can include, but are not limited to, at least one taggant, metal flakes, or other detectable markers. The ultimate size and area covered by the optically clear window 1010B depends on the desired implementation.

Referring now specifically to FIG. 5, a cross-sectional view of an alternative to the structure of FIG. 3, taken along line 4-4 is shown. In this embodiment, the structure is similar to that of FIG. 3 and FIG. 4, with a shown a substrate layer 502, an adhesive substrate layer 504 followed by a dendritic pattern 506 where the dendritic pattern layer is laminated and flattened within the structure, an optically clear layer 508, and a mask layer 510A with an optically clear window 510B, each the mask layer 510A and optically clear window 510B comprising the top face 502. As a result of the flattening of the dendritic pattern layer, air trapping within the layer may be kept to a minimum. Additional security features may be included and can include, but are not limited to, at least one taggant, metal flakes, or other detectable markers. The ultimate size and area covered by the optically clear window 610B depends on the desired implementation.

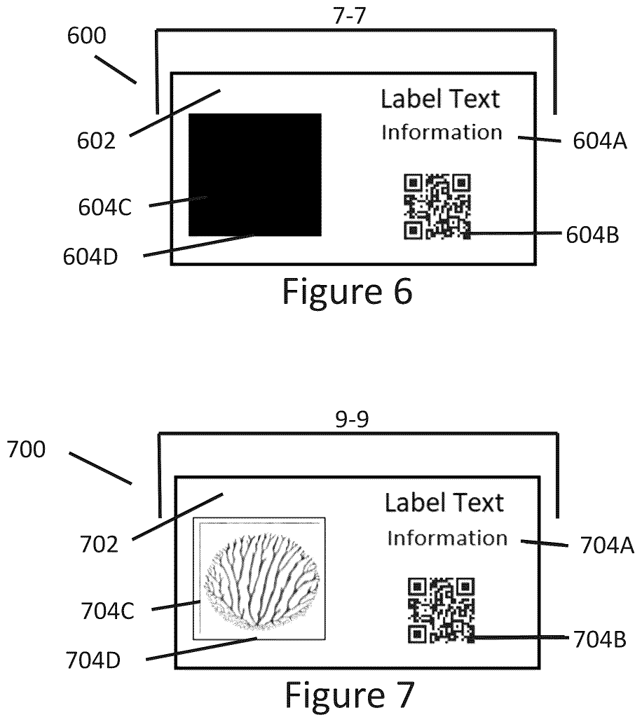

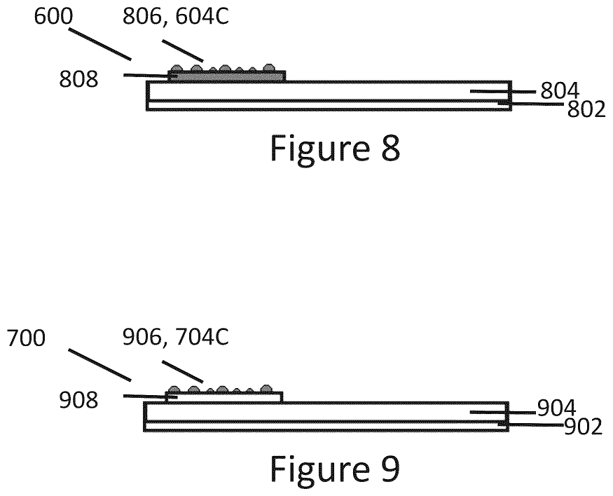

In another exemplary laminate structure, the pattern can be applied digitally and on top of the laminate structure with near infrared (NIR) inks. Such an exemplary structure is shown in FIG. 6, FIG. 7, FIG. 8, and FIG. 9. Referring specifically to FIG. 6, a top planar view of such an exemplary construction is shown. FIG. 6 is taken from the perspective of what one would see with the visible spectrum. A label 600 is shown with various components visible from its top face 602 of the label 600 including various identifying indicia 604A, 604B and 604C. In this embodiment, there is a place for text identifying information 604A, a QR code 604B, as well as an NIR embedded dendritic pattern 604C.

Referring specifically to FIG. 7, a top planar view of such the exemplary construction of FIG. 6 is shown taken from the perspective of what one would see with under NIR light. A label 600 is shown with various components visible from its top face 602 of the label 600 including various identifying indicia 604A, 6704B and 604C. In this embodiment, there is a place for text identifying information 604A, a QR code 604B, as well as an NIR embedded dendritic pattern 604C which now allows for view of the optically isolated nature of the coating or adhesive component 604C by virtue of an outer border 604D now distinguished by the NIR light.

Referring specifically to FIG. 8, a cross-sectional view of an alternative to the structure of FIG. 6 taken along line 8-8 is shown. In this embodiment shown is a substrate layer 802, an NIR reflecting base layer 804, a dendritic ink layer 806 and a label film base 808. Additional security features may be included and can include, but are not limited to, at least one taggant, metal flakes, or other detectable markers. The coating or adhesive component 806 can include a pigment opaque to both visible light as well as NIR. This can be in contrast to the label film base 808 which can have NIR dye which is opaque in visible light spectrum while remaining transparent in NIR. Therefore, with this configuration, the base film becomes transparent while all identifying features are not. This concept is further illustrated in FIG. 9, as FIG. 9 is a cross section taken along line 9-9 in FIG. 7. As can be seen, FIG. 9 is shown taken from the perspective of what one would see with under NIR light. In this case, with a substrate layer 902, an NIR reflecting base layer 904, a coating or adhesive layer 906 and a label film base 908 only the coating or adhesive 906 colored with a pigment absorbs the NIR light. In an exemplary embodiment, the pigment is based on carbon black.

In the instance of all of the above embodiments discussed, contrasting colors between the adhesive layer and the main label color is required. For example, if the coating or adhesive layer is underneath optically clear film, the adhesive layer may be pigmented black and the main label may be white. In other embodiments when NIR is being used, the NIR reflecting background can be white or can be metallic when contrasted with the pigmented adhesive.

Alternatively, there could be an embodiment that is a mixture of the above disclosed. Namely, there could be at least two patterns on top of each other. A first pattern could be visible, while a second could be read with an infrared reader. Alternatively, the patterns could be read with an antenna for a Radio Frequency Identifier (RFID).

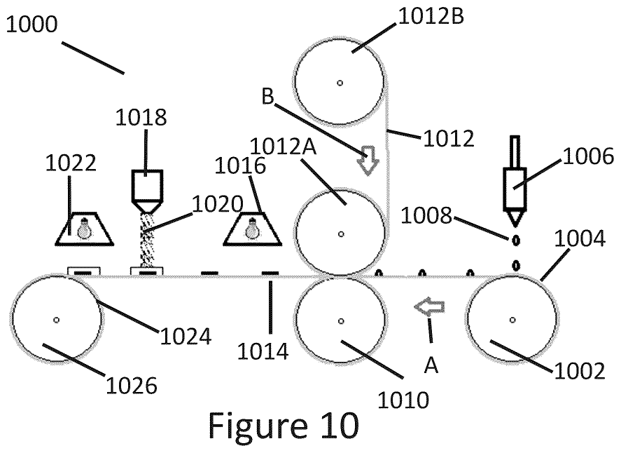

Referring specifically to FIG. 10, an exemplary roll-to-roll manufacturing unit 1000 is shown. Specifically, there is an unwinding roll 1002 operative to unroll a substrate 1004. The substrate 1004 is disposed above an ink dispensing unit 1006 where the ink 1008 is deposited in a dendritic pattern and the substrate 1004 continues along the path in the direction of arrow “A”. While in the illustrated embodiment, a single ink unit is shown, it will be understood that multiple ink units may be included in a desired implementation. In the exemplary embodiment, the substrate 1004 is made of a polymeric film. Specific polymeric films can include, but are not limited to polyethylene terephthalate (PET), biaxially oriented polypropylene (BOPP), polyethylene (PE), and polyurethane (PU). In the exemplary embodiment the surface energy is greater than about 30 dyne/cm. In another embodiment the surface energy is greater than about 40 dyne/cm. The ink 1008 is deposited in small consistent droplets in a dendritic pattern and can be deposited in a single pass, or may be deposited in multiple passes. Specifically, a trunk portion can be applied followed by a branch portion. In the exemplary embodiment the substrate 1004 will have sufficient temperature resistance and sufficient ink adhesion depending on the desired implementation.

As the substrate 1004 continues along the path it is placed between a laminator pressing roll 1010 and a web roll 1012. The web roll 1012 moves in the direction of arrow “B” and is driven by its own unwind roller 1012A and a second roller 1012B pressing the substrate 1004 and ink 1008 together with the web roll 1012. Specifically, the wet ink droplets can be flattened between the two different film surfaces and the dendritic pattern may also be formed or elongated at this time. In an exemplary embodiment, the web roll 1012 may be the same material as the substrate 1004. In an alternative embodiment, the web roll 1012 is a different material than the substrate 1004. In the alternative embodiment, the web roll 1012 could be a lower energy film such as a silicone liner. For example, if a polar ink were to be used, it may be easier to clean the silicone and reuse the silicone roll. In yet another alternative embodiment, the web roll 1004 may be made of hard silicone with peroxide cured nitrile or other similarly situated materials.

After the contact between the laminator pressing roll 1010 and the web roll 1012, a resultant flattened material 1014 is formed and continues along the direction of arrow “A” and is moved by a first radiation source 1016. The first radiation source 1016 can be a UV curing lamp or an IR oven and is operative to cure or dry the ink 1008. After this, the flattened material 1014 can be placed below a spray unit 1018 that can apply a coating or varnish 1020 using a depositor unit over the flattened material 1014. Then, the flattened material 1014 continues along the direction of arrow “A” and is moved by a second radiation source 1022. The second radiation source 1022 can be a UV curing lamp or an IR oven and is operative to cure or dry the ink varnish 1020. While in the exemplary embodiment, the flattened material 1014 moves along a path, in other embodiments the first radiation source 1016 or the second radiation source 1022 each or both may move. Then, the resultant material 1024 may be wound on a winding station roll 1026.

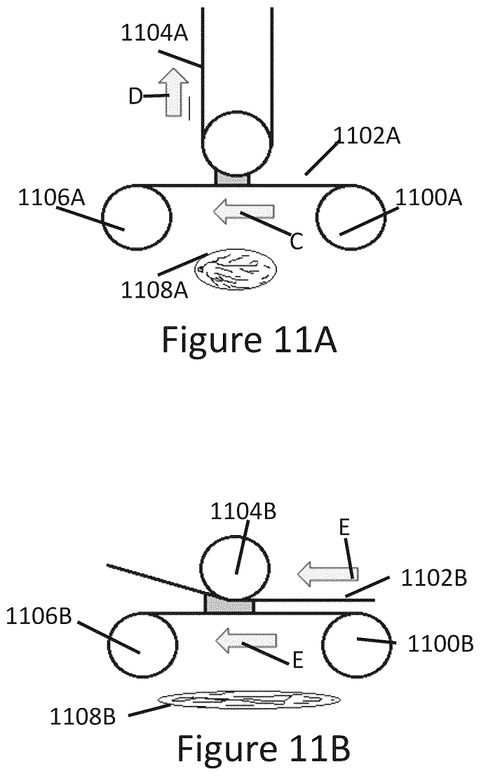

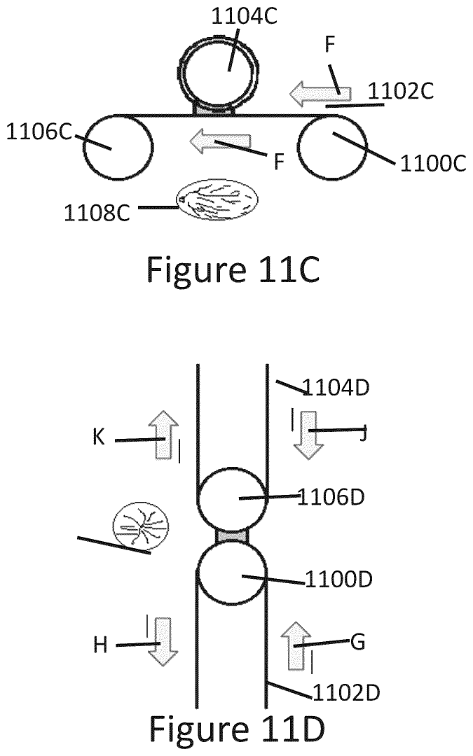

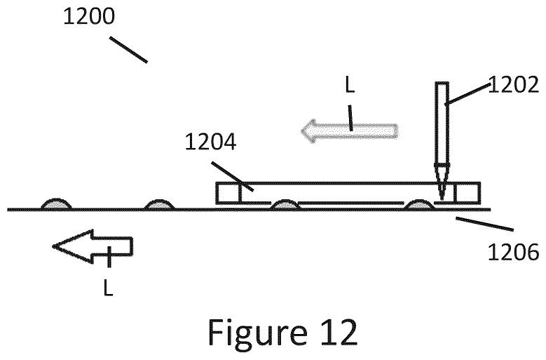

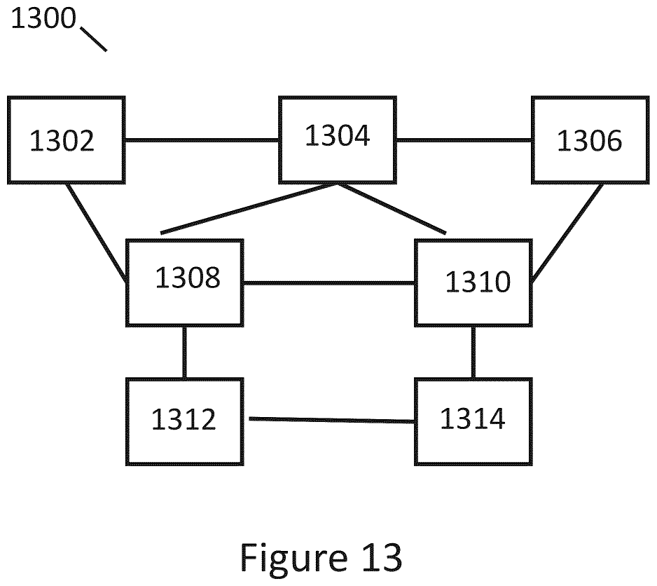

As seen in FIG. 11A-FIG. 11D, various alternative embodiments of the pattern of the ink in different simplistic exemplary roll-to-roll manufacturing units is shown. Specifically referring to FIG. 11A, a similar roll-to-roll manufacturing unit from FIG. 10 is shown. In this embodiment, the unwind roll 1100A moves a substrate 1102A in the direction of arrow “C” while a pressing web 1104A moves in the direction of arrow “D”, where it is then wound by a winding roll 1106A. As a result, of the contact of the pressing web 1104A, there is 90-degree lamination that results in slightly elongated dendrites 1108A, as is shown below.

Now referring to FIG. 11B, an alternative embodiment of embodiments of the pattern of the ink in different simplistic exemplary roll-to-roll manufacturing unit is shown. In this embodiment, an unwind roll 1100B moves a substrate 1102B in the direction of arrow “E” while a pressing web 1104B moves in the same direction of arrow “E”, where it is then wound by a winding roll 1106B. As a result, of the contact of the pressing web 1104B, there is a greater than 90 degree of lamination that results in more than slightly elongated dendrites 1108B, as is shown below.

Now referring to FIG. 11C, an additional alternative embodiment of embodiments of the pattern of the ink in different simplistic exemplary roll-to-roll manufacturing unit is shown. In this embodiment, the unwind roll 1100C moves the substrate 1102C in the direction of arrow “F” while a silicone film jacket PDMS rubber roll 1104C presses the ink, where it is then wound by a winding roll 1106C. As a result, of the contact of the pressing web 1104C, there is a 90 degree of lamination that results in slightly elongated dendrites 1108C, as is shown below. Alternatively,

Now referring to FIG. 11D, yet another alternative embodiment of embodiments of the pattern of the ink in different simplistic exemplary roll-to-roll manufacturing unit is shown. In this embodiment, the unwind roll 1100D moves the substrate 1102D in the direction of arrow “G” while a pressing liner web 1104D presses the ink, where it is then wound by a winding roll 1106D moving in the direction of arrow “H” while the pressing liner web moves in the direction of arrow “J” and along with arrow “K”. As a result, of the contact of the pressing web 1104D, there is a 180 degree of lamination that results in dendrites of similar size prior to lamination 1108D, as is shown to the left. In yet another embodiment (not shown), it is possible that two substrates could be deposited with a dendrite structure and then pressed together in order to form a dendritic pattern.

In some exemplary embodiments, the shape of the dendrite may be primed. In these embodiments, a standard shape may be placed down at a specific location on a substrate. Within this standard shape, there may be place for an RFID or other optical sensing functional unit. This standard shape can make up the trunk of the dendritic shape. This shape can be achieved through applying a force to the substrate at the same time or subsequent to ink deposition. The force can be, but is not limited to electrostatic effects, magnetism, and recessions and/or stamps within the rollers. In the case of electrostatic effects, there may be a polytetrafluoroethylene or other similarly situated coating that allows the ink to migrate nearly freely, and then when passed through a nip or other similarly situated roll may allow the ink to flow to the path of least resistance depending on the rheology properties. The ink would need to be charged with particles in some way in order to be affected by magnetism. Further, the ink may merely be rheology controlled and would allow a first pattern to be deposited that may remain consistent or relatively consistent throughout the process of forming the final shape.

Additionally, after the trunk shape is formed, additional ink is deposited in order to form the branches complete the dendritic pattern. The additional ink, when deposited can also be controlled via shape including through applying a force to the substrate at the same time or subsequent to ink deposition. Alternatively, the ink may be deposited by a depositor in a specific pattern in order to result in the branch pattern. Further, the branch pattern and trunk pattern can be changed through lamination, as is discussed above with respect to FIGS. 11A, 11B, 11C, and 11D.

An additional way to apply the ink may be using a rotary screen 1200. In this embodiment, there is a squeegee 1202, a flat screen 1204 that has stencil with narrow perforations 1204A. In this embodiment, a substrate 1206 moves in the direction of arrow “L” along with the squeegee 1202 moving in the same direction. This allows a pattern to be placed on the substrate based on a stencil sort of pattern.

In other embodiments, the pattern may be computationally generated. In this embodiment, the whole or part of the pattern can be defined via an electrode array that is electronically controlled under a surface that the. Each electrode within the electrode array can be actuated between an active and an inactive state by a controller operatively connected to them. The electrodes would then manipulate an electrically responsive fluid to form a pattern via forces created by an electric or magnetic field.

Alternatively, a pattern may be printed directly on a curved substrate, acting as a roller. In this embodiment, the ink may be deposited and the second roller would have a web similarly situated to other disclosed embodiments. The web would come into contact with the drop and then be lifted, leaving the pattern on the bottle.

Additionally, one could make a patterned structure, temporarily laminate an additional blank structure and abut the patterned structure with the blank structure. This would allow for two different patterns to exist and be mirror images of one another.

### Methods

Having discussed various components of the apparatus, exemplary methods and methodologies of operation will be discussed.

Exemplary embodiments provide for a method, comprising: providing a printer system, comprising: a control unit, at least one ink unit, a substrate on a first roll, a laminator with a pressing roll, at least one radiation source, and a second roll. At least a portion of the substrate on the first roll is unrolled and a dendritic trunk pattern on a substrate via an ink is generated. Then, a dendritic branch pattern of ink is generated on the substrate. Next, a at least one layer is laminated onto the ink using at least one pressing roll, the ink is then exposed and cured with at least one radiation source resulting in asset dendritic ink pattern. The resultant laminate is then wound onto the second roll. In certain embodiments a varnish or top coat is applied to the laminate after the dendritic ink pattern is deposited. Additionally, a layer that is optically transparent may be laminated over the dendritic ink pattern. In an exemplary embodiment, the generation of the ink pattern occurs through depositing by at least one piezo controlled device operating between about 1000 Hz and about 10000 Hz, disposed between about 0.1 to about 3 mm longitudinally above the substrate. In certain embodiments the piezo controlled device can be heated up to about 100° C. and the depositing occurs through is at least one automatic syringe with an internal needle diameter between about 0.1 and about 0.5 mm and disposed between about 0.1 to about 1 mm longitudinally above the substrate.

### Feature Deposition, Detection, and Extraction

Additional embodiments are directed towards a system to image features a patterned coating on a laminate and store the image and its identified features. Specifically, the exemplary system is schematically shown in FIG. 13. An exemplary system 1300 can comprise, at least one detector 1302; at least one processor 1304; and at least one memory unit 1306; and wherein the at least one detector 1302 is operative to image a dendritic ink on a laminate, the at least one processor 1304 is operative to identify features of the dendritic ink, and the at least one memory unit 1306 is operative to store the image and its identified features. The system 1300 may further comprise at least one coating unit 1308 operative to deposit the dendritic ink; at least one lamination unit 1310 operative to combine one or more layers of a laminate; and at least one ink unit 1312, wherein the ink unit can also be operative to deposit near-infrared (NIR) ink to the top of the laminate. Additionally, other embodiments can include a depositor unit 1314 that are operative to deposit the dendritic ink. While in the exemplary figure different components are connected, this will be seen as exemplary and merely an example of how things could be physically coupled. In other embodiments (not shown) the connection may be electrically coupled or connected through wireless means in order to communicate information and/or data with other components and such illustration will not be seen as limiting. Deposition can occur through multiple methods including but not limited to, droplet dispensing, gravure coating, screen printing, or rotary screen application.

The exemplary system 1300 can operate through passing the patterned coating laminate past the at least one detector 1302, where the at least one detector 1302 takes a measurement and this can be in the form of scale-invariant feature transform (SIFT) descriptors. These SIFT descriptors can then be processed and stored by a memory unit in a feature database. The SIFT descriptors can be for example, in the form of a vector of 128 floating points values that allows for features to be tracked and later matched by descriptors that are robust under varying viewing conditions and are not dependent on the features illumination or scale. In short, the image content is reduced to a set of points used to detect similar patterns in other images. Thus, the feature vector point is used to extract serialization information and create a digital identification for the laminate with the dendritic pattern deposited thereon.

Exemplary embodiments are also directed towards a method comprising: processing a provided image of a dendritic pattern on a laminate; analyzing the provided image against a database of recorded dendritic patterns; matching the provided image with an entry in the database; and providing a response corresponding to the entry. This embodiment, or another exemplary embodiment can be when the laminate is multilayered, the dendritic pattern is longitudinally under at least one layer of the laminate. Alternatively, the dendritic pattern is located on top of the laminate. In the exemplary embodiment the dendritic pattern is discontinuous and semi-random and the pattern of the coating has a coverage over the area of at least one layer of the laminate greater than about 2% and less than about 75%.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0. % of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A system comprising:
a control unit;
at least one motor;
at least one ink unit adapted to dispense ink in that can be formed into a dendritic trunk pattern;
at least one ink unit adapted to dispense ink in that can be formed into a dendritic branch pattern;
a first roll driven by the at least one motor operative to unwind the substrate;
a laminator unit with at least one roll assembly; and
a second roll driven by the at least one motor and adapted to wind a laminate structure.

2. The system of claim 1, further comprising:
a spray unit operative to spray a protective varnish.

3. The system of claim 1, further comprising:
at least one radiation source operative to cure the ink into a dendritic ink pattern.

4. The system of claim 3, the at least one radiation source is selected from the group of: an actinic radiation source and an infrared radiation source.

5. The system of claim 1, wherein the at least one ink unit is at least one piezo controlled device operating between about 1000 Hz and about 10000 Hz, disposed between about 0.1 mm to about 3 mm longitudinally above the substrate.

6. The system of claim 1, wherein the at least one ink unit is at least one solenoid actuated pneumatic nozzle operating between about 100 Hz and about 1000 Hz.

7. The system of claim 1, wherein the at least one ink unit is at least one automatic syringe with an internal needle diameter between about 0.1 mm and about 0.5 mm and disposed between about 0.1 mm to about 1 mm longitudinally above the substrate.

8. The system of claim 1, further comprising:
a substrate adapted to receive the ink, wherein the substrate is polymeric and has greater than about 30 dyne/cm of surface energy.

9. The system of claim 8, further comprising:
a second layer, wherein the second layer is applied through the laminator unit and wherein the second layer has less than or equal to the surface energy of the substrate.

10. The system of claim 9, wherein the second layer is the same material of the substrate.

11. The system of claim 9, wherein the second layer is a different material as the substrate.

12. The system of claim 1, wherein the ink has a viscosity that is between about 1000 cps and about 5000 cps.

13. The system of claim 1, wherein the ink comprises:
at least one of pigments, conductive metal flakes, sintered metal, and fused metal.

14. A method, comprising:
providing a printer system, comprising:
a control unit,
at least one ink unit,
a substrate on a first roll,
a laminator with a pressing roll,
at least one radiation source, and
a second roll;
unrolling at least a portion of the substrate from a first roll;
generating a dendritic trunk pattern via ink by the at least one ink unit onto the substrate;
generating a dendritic branch pattern via ink by the at least one ink unit onto the substrate;
laminating at least one layer onto the ink with the laminator and the pressing roll;
exposing the ink;
curing the ink with the at least one radiation source resulting in a set dendritic ink pattern; and
winding a resultant patterned ink containing laminate onto the second roll.

15. The method of claim 14, further comprising:
providing a varnish to the laminate.

16. The method of claim 14, wherein exposing further comprises:
laminating an optically transparent layer over the dendritic ink pattern.

17. The method of claim 14, further comprising:
recording a shape of the exposed section of the dendritic ink containing laminate with a detector; and
creating a data bearing record related to the shape.

18. The method of claim 14, wherein the generating of the ink pattern occurs by at least one piezo controlled device operating between about 1000 Hz and about 10000 Hz, disposed between about 0.1 to about 3 mm longitudinally above the substrate.

19. The method of claim 18, further comprising:
heating the piezo controlled device to about 100° C.

20. The method of claim 14, wherein the generating of the ink pattern occurs by at least one automatic syringe with an internal needle diameter between about 0.1 and about 0.5 mm and disposed between about 0.1 to about 1 mm longitudinally above the substrate.
